(19) United States
(12) Patent Application Publication
(10) Pub. No.: US 2009/0195565 A1
(43) Pub. Date: Aug. 6, 2009

(54) LIQUID CRYSTAL DISPLAY DEVICE CONTROLLING METHOD, LIQUID CRYSTAL DISPLAY DEVICE, AND ELECTRONIC APPARATUS

(75) Inventor: Fusashi KIMURA, Matsumoto-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: Epson Imaging Devices Corporation, Nagano (JP)

(21) Appl. No.: 12/248,188

(22) Filed: Oct. 9, 2008

(30) Foreign Application Priority Data
Feb. 1, 2008 (JP) 2008-022426
Jul. 31, 2008 (JP) 2008-197470

(51) Int. Cl. G09G 5/10

(52) U.S. Cl. 345/690

(57) ABSTRACT

A first gray scale area, and a second gray scale area are set for the liquid crystal display device of the invention. Both of the gray scale areas contain a plurality of gray scale values, and gray scale values in the second gray scale area are larger than those in the first gray scale area. When the image data belong to the first gray scale value, the image data is corrected such the lightness is increased. When the image data belong to the second gray scale area, the image data is not corrected, or corrected with a smaller correction amount.

### BACKGROUND

1. Technical Field

The present invention relates to a liquid crystal display device controlling method, a liquid crystal display device, and an electronic apparatus, and particularly to a technique capable of controlling a viewing angle of the liquid crystal display device by an input image data correction process and an illumination brightness adjustment process.

2. Related Art

In general, a liquid crystal display device includes a liquid crystal panel which sets a light outgoing property by controlling a state of liquid crystal alignment and a display unit which includes an illumination unit illuminating illumination light to the liquid crystal panel. The display unit of the liquid crystal display device generally has a configuration in which the illumination unit as a backlight is disposed on the rear of a transmissive liquid crystal panel. However, the illumination unit may be configured as a front-light unit and a reflective liquid crystal panel may be used.

Since light outgoing from the liquid crystal panel has a viewing angle dependency depending on an alignment state of liquid crystal molecules, a bright image having good contrast can generally be obtained in a range (front side) of low viewing angles. However, since an image becomes dark in a range (lateral side) of high viewing angles and thus the contrast may deteriorate, it is known that sufficient visibility cannot be obtained. In addition, there is known a display apparatus capable of switching between a narrow viewing angle mode and a wide viewing angle mode by disposing a viewing angle controlling liquid crystal panel on a visible side of a displaying liquid crystal panel using a property of such a liquid crystal panel and switching the alignment state of the viewing angle controlling liquid crystal panel. In such a display apparatus, as a method of preventing an image in a high viewing range from being viewed in the narrow viewing angle mode, as disclosed in JP-A-2007-11316, a method of decreasing the illumination brightness of the illumination unit (backlight unit) in the narrow viewing angle mode is suggested in order to improve a capability switching the narrow viewing angle mode and the wide viewing angle mode.

On the other hand, in the liquid crystal display device, a predetermined gray scale is displayed in every pixel in accordance with a gray scale value of input image data. Alternatively, a gray scale value of image data is subjected to a correction process and then the predetermined gray scale is displayed in every pixel in accordance with the gray scale value of the image data subjected to the correction process. For example, there is known a method of improving a light outgoing ratio (transmissivity or reflectance) of a liquid crystal panel by a lightness correction process of increasing a gray scale value of brightness data obtained from the image data, and decreasing the illumination brightness of the illumination unit to reduce power consumption (for example, see JP-A-2006-306532).

There is also known a display apparatus capable of switching between the narrow viewing angle mode and the wide viewing angle mode by changing some colors of a display image and varying the illumination brightness of the illumination unit (for example, see JP-A-2007-163823).

However, the method disclosed in JP-A-2007-11316 has a problem in that it is difficult to realize miniaturization or thinness of a recent display apparatus since the viewing angle controlling liquid crystal panel is additionally provided in addition to the displaying liquid crystal panel and thus a display body becomes thick.

The method disclosed in JP-A-2006-306532 has an advantage of reducing power consumption of the illumination unit, but has a problem in that a viewing angle property easily varies due to the lightness correction process since image brightness is maintained on the whole by decreasing the illumination brightness of the illumination unit to reduce power consumption, instead of increasing the light outgoing ratio of the liquid crystal panel by the lightness correction process. Specifically, in a normal liquid crystal panel, a difference of the light outgoing ratio between adjacent gray scales is large in a low viewing range (front side) of a high gray scale area, but the difference of the light outgoing ratio between the adjacent gray scales is small in the high viewing range (lateral side). Therefore, when an amount of correction in the lightness correction process is large, the light outgoing ratio of an image relatively decreases in the high viewing range and thus the viewing angle is narrowed. On the contrary, when the amount of correction is small, the viewing angle is not narrowed that much. Accordingly, there occurs a problem in that variation in the viewing angle is large in accordance with the amount of correction and the viewing angle property is not stabilized.

The method disclosed in JP-A-2007-163823 is capable of controlling the viewing angle to be narrowed or widened using a display property of the liquid crystal panel. The viewing angle of a display area where a specific color is displayed can be controlled since the gray scale of some colors of a display image is changed. However, there occurs a problem in that it is difficult to surely control the viewing angle of the entire image to be narrowed or widened.

### SUMMARY

An advantage of some aspects of the invention is that it provides a structure capable of appropriately controlling a viewing angle property in accordance with various images using a primary light outgoing property of a liquid crystal panel.

According to an aspect of the invention, there is provided a method of controlling a liquid crystal display device which includes a liquid crystal panel with pixels displaying an image in accordance with a gray scale value. The method includes: setting a first gray scale area containing a plurality of gray scale values and a second gray scale area containing a plurality of gray scale values larger than the gray scale values contained in the first gray scale area; performing a first lightness correction process of increasing lightness of the image on image data when the gray scale values which are based on the image data belong to the first gray scale area; and performing no lightness correction process on image data or a second lightness correction process to correct the image data by a correction amount smaller than a correction amount of the first lightness correction when the gray scale values which are based on the image data belong to the second gray scale area. Here, the first gray scale area is a gray scale area higher than a reference gray scale domain which is a reference, and the second gray scale area is a gray scale area lower than the reference gray scale domain.

In a general liquid crystal display device, an image corresponding to image data on a low gray scale side has a low viewing angle dependency of a light outgoing ratio. On the contrary, an image corresponding to image data on a high gray scale side has a high viewing angle dependency of the light outgoing ratio. That is, in a case of a dark display, a lightness difference between a front view and a lateral view is not large. However, in a case of a bright display, the lightness difference between the front view and the lateral view is large.

According to the method of controlling the liquid crystal display device, the image data of a gray scale value included in the first gray scale area on the low gray scale side having the lower the viewing angle dependency is subjected to the first lightness correction process in which an amount of correction is relatively large. In this way, the display image becomes bright since the image data is shifted toward the high gray scale side. On the other hand, the image data of a gray scale value included in the second gray scale area on a high gray scale side having the large viewing angle dependency is not subjected to the first lightness correction process, but subjected to the second lightness correction process in which an amount of correction is smaller than the amount of correction of the first lightness correction process. Therefore, the image data on the high gray scale side is rarely shifted. The viewing angle dependency of the display image rarely varies, compared to the viewing angle dependency before correction. As a result, it is possible to obtain a bright display image in which the variation in the viewing angle of the image display is suppressed on the whole.

According to the method of controlling the liquid crystal display device, the liquid crystal panel may include the plurality of pixels. The method further may include: determining one of the gray scale values as a representative value on the basis of a plurality of the image data input to the plurality of pixels; performing the first lightness correction process on the plurality of image data input to the plurality of pixels when the one gray scale value belongs to the first gray scale area; and performing no lightness correction process on the plurality of image data input to the plurality of pixels or the second lightness correction process to correct the plurality of image data by the correction amount smaller than the correction amount of the first lightness correction when the one gray scale value belongs to the second gray scale area. Here, the one gray scale value which is the representative value refers to a gray scale value belonging to the gray scale range which is higher the gray scale range belonging to the gray scale value of another image data among input image data in frequency and substantially determines image details of the image data, or a representative value such as an average vale or a median value of the gray scales of the image data. By determining the lightness correction process in accordance with the gray scale value which is the representative value, it is possible to uniformly correct the entire image and thus surely maintain the image details.

In this case, when the gray scale value which is the representative value of the image data is present in a domain lower than the reference gray scale domain and the gray scale value which is the representative vale of the image data subjected to the lightness correction process is present in a domain higher than the reference gray scale area, the amount of correction is decreased or the lightness correction process is not performed. In this way, when the gray scale value after a normal lightness correction process is present in the high viewing angle and high gray scale domain, the contrast of an image may deteriorate in a range of the high viewing angle, likewise with a case where the gray scale value before the lightness correction process is present in the high viewing angle and high gray scale domain. Accordingly, by reducing the amount of correction or performing no lightness correction process in this case, it is possible to suppress the variation in the viewing angle property.

According to the method of controlling the liquid crystal display device, the liquid crystal display device may further include an illumination unit illuminating the liquid crystal panel, and the illumination unit may select a first state of emitting first brightness light and a second state of emitting second brightness light lower than the first brightness light in brightness. The method may further include performing the first or second lightness correction process in the second state.

In a so-called power saving control mode in which the brightness of the illumination unit is decreased to reduce power consumption, it is necessary to ensure the brightness of the display image by performing the lightness correction process on the image data by a degree of decreasing the brightness of the illumination unit. By applying the control method described above to the power saving control mode, it is possible to obtain a bright display image while suppressing the variation in the viewing angle property even when the brightness of the illumination unit is decreasing.

The method of controlling the liquid crystal display device may further include performing a third lightness correction process of decreasing lightness of the image on the image data in the first state.

When the brightness of the illumination unit is relatively high, the corrosion of decreasing the lightness of the display image may be performed on the image data. That is, by shifting the gray scale of the display image toward the low gray scale side in which a difference of the light outgoing ratio of the display image is small between the high viewing angle range and the low viewing angle range, it is possible to display an image in the high viewing angle mode in which the viewing angle is widened.

According to another aspect of the invention, there is provided a method of controlling a liquid crystal display device which includes a liquid crystal panel with pixels displaying an image in accordance with a gray scale value and an illumination unit illuminating the liquid crystal panel. The illumination unit selects a first state of emitting first brightness light and a second state of emitting second brightness light lower than the first brightness light in brightness. The method includes performing a third lightness correction process of decreasing lightness of the image on image data in the first state.

According to the method of controlling the liquid crystal display device, the lightness correction process of decreasing the lightness on the image data. That is, the image data of the display image is shifted toward the low gray scale side in which the difference of the light outgoing ratio is small between the high viewing angle range and the low viewing angle range. Accordingly, the viewing angle property of the liquid crystal display device is widened. On the other hand, by increasing the brightness of the illumination unit, it is possible to prevent the display brightness from decreasing.

The method of controlling the liquid crystal display device may be applied to all liquid crystal display devices having a viewing angle dependency. For example, the method may be particularly applied to a liquid crystal display device such as a liquid crystal display device using TN (Twisted Nematic) liquid crystal, an ECB mode liquid crystal display device, or an STN mode liquid crystal display device having the high viewing angle dependency. Of course, the method may be applied to a liquid crystal display device such as a vertical alignment mode liquid crystal display device or a lateral electric field mode liquid crystal display device having a low viewing angle dependency.

In the method of controlling the liquid crystal display device, the low viewing angle range is in the range from 0° to 20° and the high viewing angle range is in the range of 35° to 60°. The low viewing angle range and the high viewing angle range of the liquid crystal panel are particularly not limited. However, it is generally better to set the amount of correction of the image data with reference to the above ranges in view of the viewing angle of TN (Twisted Nematic) liquid crystal.

As for the liquid crystal panel used for the control method described above, in the high viewing angle range, an average value of the difference of the light outgoing ratio between the adjacent gray scales in the high gray scale domain is smaller than an average value of the difference of the light outgoing ratio between the adjacent gray scales in a domain (high viewing angle and low gray scale domain) lower than the reference gray scale domain. In particular, such a property is obtained as a viewing angle property of TN (Twisted Nematic) liquid crystal. In this case, in the high viewing angle range, the difference of the light outgoing ration between the adjacent gray scales in a domain lower than the reference gray scale domain is relatively large, and the difference of the light outgoing ratio between the adjacent gray scales in the domain higher than the reference gray scale domain is relatively small. In the power saving control mode, a difference of the viewing angles between the low viewing angle range and the high viewing angle range which is obtained by the lightness correction process to the gray scale value larger than the reference gray scale domain is larger. Accordingly, in the power saving control mode, it is possible to further improve an advantage of suppressing or interrupting the lightness correction process to the high gray scale domain. Moreover, in the wide viewing angle control mode, the difference of the light outgoing ratio of the high gray scale domain in the high viewing angle range is relatively small and the difference of the light outgoing ratio of the low gray scale domain is relatively large. Accordingly, a decrease ratio of lightness in the low viewing angle range is larger than a decrease ratio of lightness in the high viewing angle range by the lightness correction process to the domain lower than the reference gray scale domain. As a result, the advantage of the wide viewing angle is further improved, and thus the viewing angle dependency can be more reduced in the wide viewing angle control mode.

According to still another aspect of the invention, there is provided a liquid crystal display device in which a first gray scale area containing a plurality of gray scale values and a second gray scale area containing a plurality of gray scale values larger than the gray scale values contained in the first gray scale area are set. The liquid crystal display device includes: an image correction unit which performs a first lightness correction process on image data when the gray scale values which are based on the image data belong to the first gray scale area and performs no lightness correction process on image data or a second lightness correction process to correct the image data by a correction amount smaller than a correction amount of the first lightness correction process when the gray scale values which are based on the input image data belong to the second gray scale area; and an image display unit which displays an image on the basis of a value output by the image correction unit.

The liquid crystal display device having the above-described configuration may further include a representative gray scale value determination unit which determines one of the gray scale values as a representative value on the basis of a plurality of image data. The image correction unit performs the first lightness correction process on the plurality of image data input to the plurality of pixels when the one gray scale value belongs to the first gray scale area. In addition, the image correction unit performs no lightness correction process on the plurality of image data input to the plurality of pixels or the second lightness correction process to correct the plurality of image data by the correction amount smaller than the correction amount of the first lightness correction when the one gray scale value belongs to the second gray scale area.

The liquid crystal display device having the above-described configuration may further include an illumination unit which illuminates the liquid crystal panel; and an illumination brightness adjustment unit which selects a first state where the illumination unit emits first brightness light and a second state where the illumination unit emits second brightness light lower than the first brightness light in brightness. The image correction unit performs the first or the second lightness correction process when the illumination unit is in the second state.

According to still another aspect of the invention, there is provided a liquid crystal display device which includes a liquid crystal panel with pixels displaying an image in accordance with a gray scale value and an illumination unit illuminating the liquid crystal panel. The liquid crystal display device includes: an illumination brightness adjustment unit which selects a first state where the illumination unit emits first brightness light and a second state where the illumination unit emits second brightness light lower than the first brightness light in brightness; and an image correction unit performs a correction process of decreasing lightness of the image on image data when the illumination unit is in the first state.

According to still another aspect of the invention, there is provided an electronic apparatus including the liquid crystal display device having the above-described configuration. Examples of the electronic apparatus include an image monitor and a television receiving set necessary to have a stale wide viewing angle property, and particularly include a vehicle navigation system or an image monitor for a television receiving set necessary to have a wide view.

### BRIEF DESCRIPTION OF THE DRAWINGS

The invention will be described with reference to the accompanying drawings, wherein like numbers reference like elements.

FIG. 1 is an exploded perspective view illustrating an overall configuration of a liquid crystal display device forming a display unit of a display device according to an embodiment.

FIG. 2 is a longitudinal sectional view illustrating the liquid crystal display device.

FIG. 3 is a schematic view for explaining formation of a display image by the liquid crystal display device.

FIG. 4 is a graph illustrating a light outgoing property of a liquid crystal panel.

FIG. 5 is a schematic diagram illustrating an entire configuration example of a display apparatus.

FIG. 6 is a diagram illustrating an inner configuration of an image processing unit in detail.

FIG. 7 is a table illustrating a gray scale dependency of a light outgoing property of the liquid crystal panel.

FIG. 8 is a table illustrating transmissivity and a brightness difference between adjacent gray scale areas in the light outgoing property of the liquid crystal panel.

FIG. 9 is diagram for explaining Example 1.

FIG. 10 is diagram for explaining Example 2.

FIG. 11 is diagram for explaining Example 3.

FIG. 12 is diagram for explaining Example 4.

FIGS. 13A to 13D are graphs illustrating respective distribution of brightness before correction and after correction in Examples 1 to 4.

FIG. 14 is a schematic perspective view illustrating an example of an electronic apparatus mounted with the display apparatus according to the embodiment.

### DESCRIPTION OF EXEMPLARY EMBODIMENTS

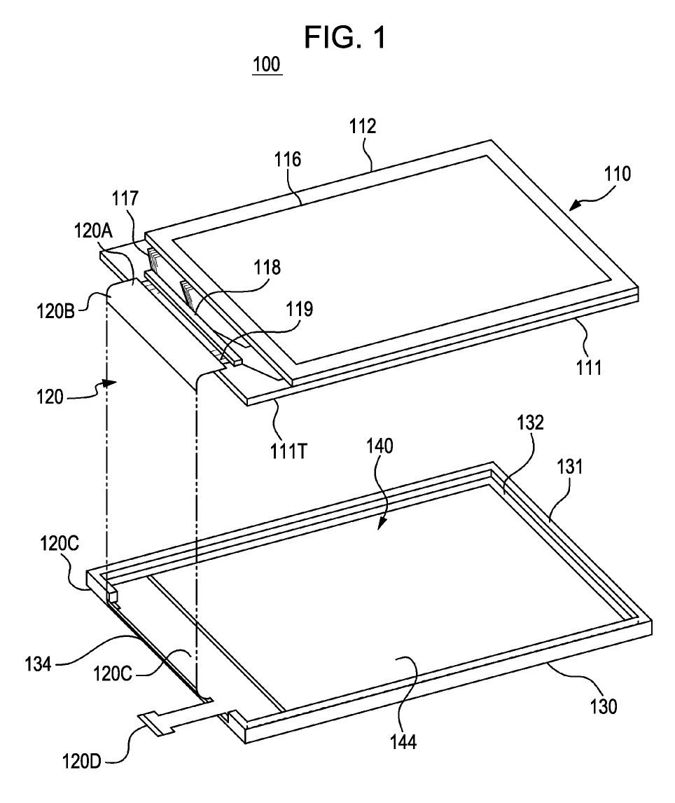

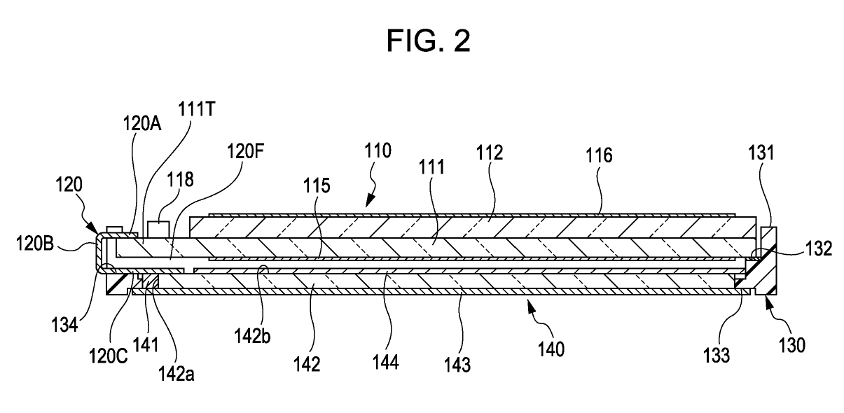

An embodiment of the invention will be described in detail with reference to the accompanying drawings. FIG. 1 is an exploded perspective view illustrating a liquid crystal display device 100 forming a display unit of a display device according to the embodiment. FIG. 2 is a longitudinal sectional view illustrating the liquid crystal display device 100. In this embodiment, the liquid crystal display device 100 includes a liquid crystal panel 110. The liquid crystal panel 110 includes a transparent substrate 111 formed of glass or the like and a substrate 112 which are adhered by a seal member (not shown) with a liquid crystal (TN liquid crystal) layer (not shown) interposed therebetween. Polarizing plates 115 and 116 are adhered on the outward appearances of the substrates 111 and 112, respectively.

A substrate extension portion 111T extending outward more than the appearance of the substrate 112 is provided in the substrate 111. In the substrate extension portion 111T, a plurality of wirings 117 extracted from the inside of a liquid crystal sealing area where the substrates 111 and 112 overlap with each other and a plurality of input wirings 119 formed in the vicinity of an edge of the substrate extension portion 111T are formed. In addition, the substrate extension portion 111T is mounted with a semiconductor chip 118 constituting a liquid crystal driving driver circuit to which the wirings 117 and the input wirings 119 are conductively connected and a wiring board 120 connectively connected to the input wirings 119.

In the liquid crystal panel 110, a display area where a plurality of pixels with electrodes applying voltage to liquid crystal molecules are provided on the inner surfaces of the substrates 111 and 112 is formed in the liquid crystal sealing area where the polarizing plate 115, the substrate 111, the liquid crystal layer, the substrate 112, and the polarizing plate 116 are laminated. Specifically, the inner surface of the substrate 111 is provided with pixel electrodes connected to active elements such as TFTs (Thin Film Transistors) which are formed of a transparent conductive material such as ITO (Indium Tin Oxide) in every pixel. In addition, the inner surface of the substrate 112 is provided with counter electrodes (common electrodes) formed of the transparent conductive material likewise and a color filter containing coloring filters such as RGB formed in a predetermined pattern.

The wiring board 120 is folded from a connection end portion 120A mounted on the substrate extension portion 111T toward the rear side through a curved portion 120B so that a rear surface portion 120C is disposed within a support frame 130. The support frame 130 is formed in a rectangular frame shape integrally formed of a synthetic resin such as a white resin and includes a side opening 134 passing the wiring board 120 therethrough. An input portion 120D formed from the rear surface portion 120C of the wiring board 120 is extracted outside the support frame 130 through the side opening 134. The input portion 120D is connected to a display interface circuit described below. A light source 141 such as an LED (Light Emitting Diode) chip is mounted in the rear surface portion 120C.

A visible side stepped surface 132 is formed inside the support frame 130 and the outside edge of the liquid crystal panel 110 is supported and fixed on the visible side stepped surface 132 by a double-stick tape.

An illumination unit 140 is provided on the rear surface side of the liquid crystal panel 110 disposed in the above-mentioned manner. The illumination unit 140 includes the light source 141 described above. A reflective sheet 143 is supported and fixed on the rear surface side stepped surface 133 formed inside the support frame 130. The polarizing plate 142 is disposed on the reflective sheet 143 and includes a light incident surface 142a formed of a single surface opposite the light source 141 and a light outgoing surface 142b formed of a surface on a side of the liquid crystal panel 110. An optical sheet 144 such as a light diffusion sheet or a light concentration sheet (prism sheet) is disposed on the light outgoing surface 142b of the polarizing plate 142.

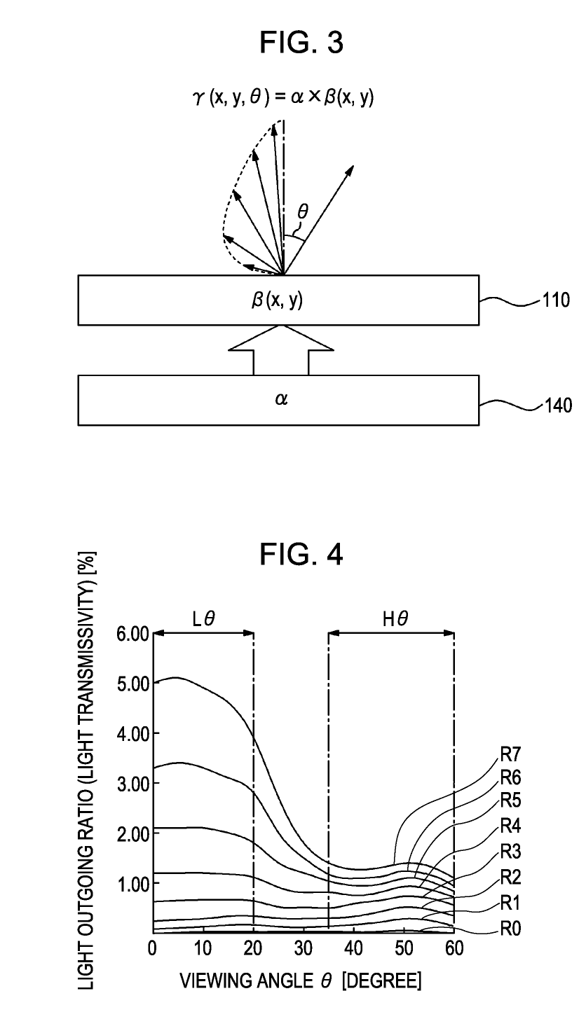

FIG. 3 is an explanatory diagram illustrating an overall configuration of an optical system according to this embodiment. In the illumination unit 140, light emitted from the light source 141 described above is incident on the polarizing plate 142 from the light incident surface 142a, and a planar light source which comes substantially uniformly from the light outgoing surface 142b is formed. Illumination light having illumination brightness a emitted from the illumination unit 140 illuminates the liquid crystal panel 110, passes through each pixel having a light outgoing ratio β(x, y) of the liquid crystal panel 110, and arrives at a viewing side.

Here, the light outgoing ratio β is a light transmissivity when the liquid crystal panel 110 according to this embodiment is a transmissive liquid crystal panel. However, when front light is provided by the illumination unit and a reflective liquid crystal panel is used as the liquid crystal panel, the light outgoing ratio corresponds to a light reflective ratio. In addition, the light outgoing ratio β corresponds to an amount of light controlled in every pixel within the display area of the liquid crystal panel 110. The (x, y) specifies a specific pixel or a location coordinate within the display area.

The light outgoing from the liquid crystal panel 110 forms a predetermined image. Pixel brightness γ of the image depends on the specific pixel with in the display area or the location coordinate and depends on a viewing angle θ which is an angle determined on the basis of a normal direction of the display surface. In general, the maximum value of the pixel brightness γ is obtained at a viewing angle 0° which is the normal direction and decreases with an increase in the viewing angle θ.

FIG. 4 is a graph illustrating a relation (a viewing angle property) between the light transmissivity as the light outgoing ratio β of the liquid crystal panel 110 and the viewing angle θ in every predetermined gray scale value of eight gray scale areas according to this embodiment. In this case, eight gray scale areas R0 to R7 are areas formed by dividing 256 gray scales of 0 to 255 of the liquid crystal panel 110 by every 32-gray scales. In addition, gray scale values of the graph indicate the light outgoing ratio in predetermined gray scales L0, L36, L73, L109, L146, L182, L219, and L255 (gray scales of which the gray scale values are 0, 36, 73, 109, 146, 182, 219, and 255) in the gray scale areas, respectively.

As known from this graph, a difference of the light outgoing ratio β between the adjacent gray scales is relatively large on the whole in the range (a low viewing angle range Lθ) of the viewing angle θ from 0° to 20°. In contrast, the difference of the light outgoing ratio β between the adjacent gray scales is relatively small on the whole in the range (a high viewing angle range Hθ) of the viewing angle θ from 35° to 60°. In particular, it can be known that the difference of the light outgoing ratio β between the adjacent gray scales on a high gray scale side in the low viewing angle range Lθ is very large, but the difference of the light outgoing ratio β between the adjacent gray scales on the high gray scale side in the high viewing angle range Hθ is very small. That is, there occurs a big difference between the low viewing angle range Lθ and the high viewing angle range Hθ in the light outgoing ratio β of the liquid crystal panel in a domain higher than a low gray scale domain every pixel.

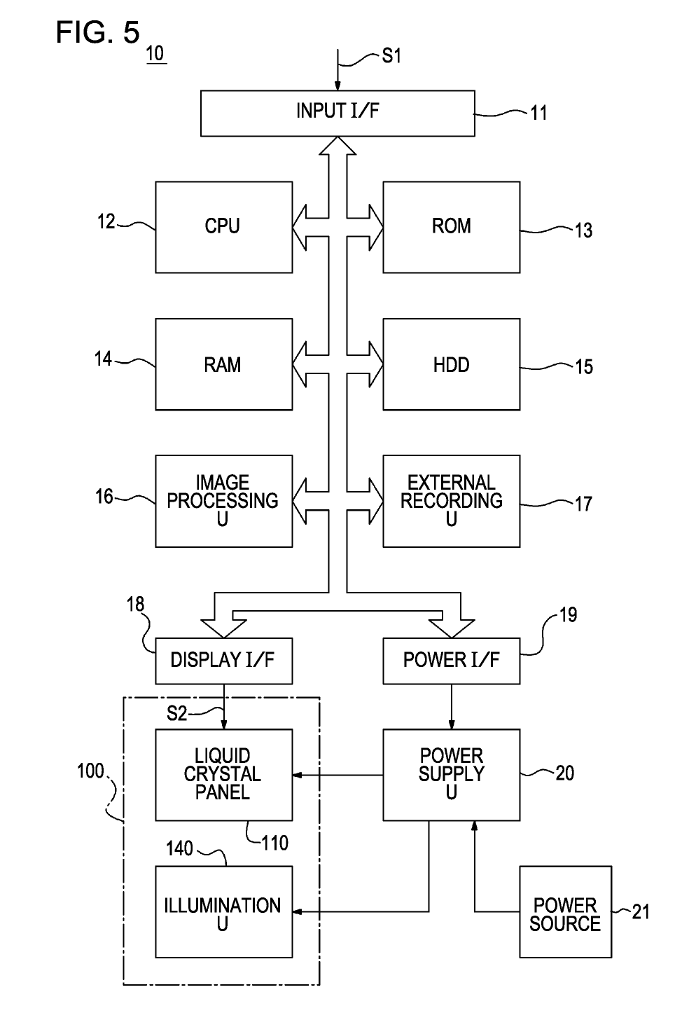

FIG. 5 is a schematic block diagram illustrating a hardware configuration of a display control system of a display apparatus 10 including the liquid crystal display device 100 according to this embodiment. The display apparatus 10 includes an input interface circuit 11 which corresponds to the display control system and inputs an image input signal S1 corresponding to input image data, a central processing unit (hereinafter, referred to as a CPU) 12 connected in common to the input interface circuit 11 and an inner bus, a ROM 13, a RAM 14, an internal recording unit such as an HDD 15, an image processing unit 16, and an external recording unit 17 reading and writing data in a CD, a DVD, or the like. As the image processing unit 16 is described in detail below, the image processing unit 16 may be configured as a hardware unit such as a logic circuit like other constituent elements or as software to be executed by the CPU 12.

The inner bus is connected to the liquid crystal display device 100 via the display interface circuit 18 and supplies an image display signal S2 to the liquid crystal panel 110 (which is included in the semiconductor chip 118) via the display interface circuit 18. In addition, the inner bus is connected to a power supply unit 20 connected to a power source 21 via a power interface circuit 19. The power supply unit 20 supplies potential necessary for the liquid crystal panel 110 or the illumination unit 140 of the liquid crystal display device 100 and particularly constitutes an output portion of an illumination brightness adjustment unit adjusting the illumination brightness of the illumination unit 140 on the basis of a power control signal supplied through the inner bus.

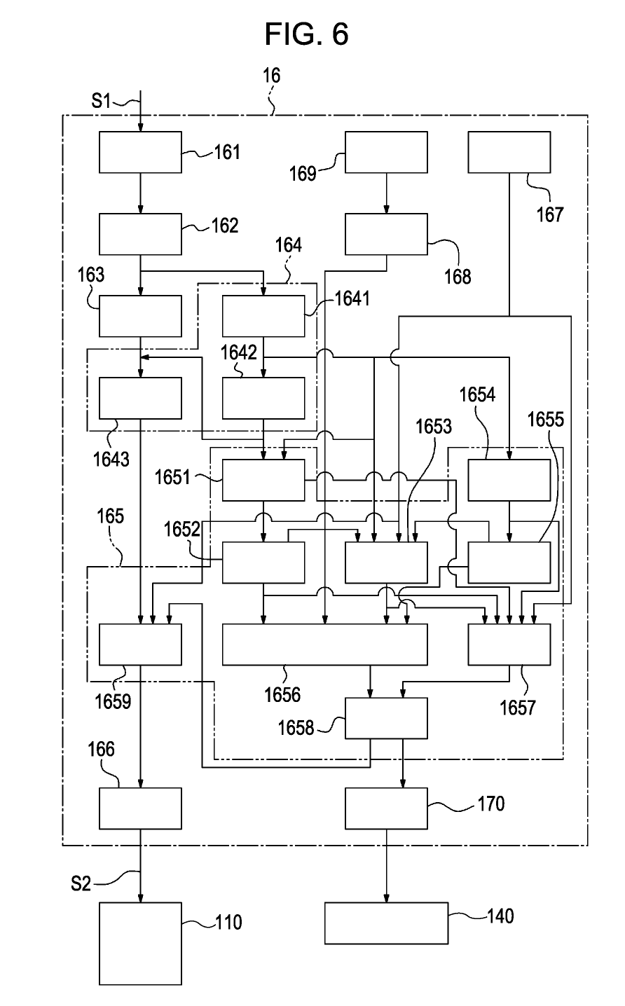

FIG. 6 is a block diagram illustrating the inner configuration or the software configuration of the image processing unit 16 shown in FIG. 5 in more detail. The image processing unit 16 constitutes an image correction unit and includes a frame image acquiring section 161, a color conversion section 162, a frame memory 163, a level correction section 164, a lightness correction section 165, an image display signal generating section 166, a correction coefficient keeping section 167, a modulated-light ratio setting section 168, a mode selection section 169, and a light volume control section 170.

The level correction section 164 includes a histogram creator 1641, a level correction parameter generator 1642, and a level correction executor 1643. The lightness correction section 165 includes a brightness sum Ys calculator 1651, an average brightness Ym calculator 1652, a coefficient sum Fs calculator 1653, a brightness sum Xs calculator 1654, an average brightness Xm calculator 1655, a correction calculator 1656, a margin correction calculator 1657, a final correction determiner 1658, and a lightness correction executor 1659.

The frame image acquiring section 161 sequentially acquires image data of respective frames of a video from the image data input through the input interface circuit 11. The color conversion section 162 converts the image data acquired by the frame image acquiring section 161 into brightness data and color difference data. The brightness data and the color difference data subjected to the conversion process are stored in the frame memory 163. In this case, the image data may be converted into gray scale values representing gray scales (for example, gray scales L0 to L255 in 8-bit image data) every RGB. In the below description, the brightness data will be handled in either case, but the brightness data of every RGB may be handled. In addition, the brightness of the acquired brightness data which is not subjected to the conversion process is denoted by X.

The level correction section 164 obtains a parameter used to specify distribution of the brightness data in the frame image, for example, a value representing the distribution such as an upper limit value or a lower limit value, and performs a level conversion of each data. Upon performing the level conversion, the histogram creator 1641 creates a histogram from the brightness data corresponding to the image data, and then the level correction parameter generator 1642 generates the parameter on the basis of the histogram.

The level correction executor 1643 converts the brightness data on the basis of the parameter and performs the level correction process. Specifically, the level correction executor 1643 converts the gray scale range of the brightness data represented by the upper limit value and the lower limit value into another gray scale range to adjust contrast. The gray scale range of the brightness data may be developed into the entire gray scale range (256 gray scales in 8-bit data) of the liquid crystal panel. The method of performing the level correction process is particularly not limited, but the level correction itself may not be performed. Brightness before the level correction process and brightness after the level correction process are denoted by X and Y, respectively.

The modulated-light ratio setting section 168 sets a modulated-light ratio τ as a parameter used to increase or decrease a volume of light emitted by the illumination unit 140. The modulated-light ratio τ is a value representing a ratio of actual brightness of the illumination unit 140 with respect to reference brightness of the illumination unit 140. The reference brightness is obtained when the modulated-light ratio τ is “1”. In this embodiment, the modulated-light ratio τ is determined depending on a setting mode selected by the mode selection section 169. Specifically, in a power saving control mode, the modulated-light ratio τ is set to a value smaller than “1” in order to reduce power consumption, thereby decreasing the illumination brightness of the illumination unit 140. On the other hand, in a wide viewing angle control mode, the modulated-light ratio τ is set to a value larger than “1” in order to achieve a wide viewing angle property of an image, thereby increasing the illumination brightness of the illumination unit 140.

The light volume control section 170 controls the power supply unit 20 to supply power to the illumination unit 140 to adjust the illumination brightness of the illumination unit 140, as described above.

The image display signal generating section 166 transmits the image display signal S2 generated in correspondence with the finally corrected image data to the liquid crystal panel 110, while synchronizing with timing at which the light volume control section 170 controls the illumination unit 140.

The lightness correction section 165 performs the level correction process described above and a lightness correction process of decreasing variation in the brightness occurring in the image by illumination. For example, a definition equation of the lightness correction process is defined as follows:

Z(Y)=F(Y)×G1+Y (1).

In Formula (1), Z indicates the brightness after correction and G1 indicates a reference correction degree in predetermined brightness. In addition, F(Y) indicates a correction coefficient representing a ratio of a value to be corrected in the respective brightness Y with reference to the reference correction degree G1. Accordingly, an actual correction degree for the brightness Y is F(Y)×G1.

When data of all the brightness Y is uniformly subjected to the corrosion process, F(Y)=1. In this case, by deciding F(Y) as an appropriate function in accordance with a light outgoing property for the gray scale values of the liquid crystal panel 110, it is possible to prevent the contrast of the brightness data subjected to the lightness correction process from deteriorating.

The reference correction degree G1 is different depending on the power saving control mode or the wide viewing angle control mode. For example, in the power saving control mode, the reference correction degree G1 becomes a positive value. In the wide viewing angle control mode, the reference correction degree G1 becomes a negative value. After deciding F(Y) described above, the reference correction degree G1 is determined so that an average brightness Xm of the brightness X before correction is equal to a product of an average value Zm of the brightness Z after correction and the modulated-light ratio τ described above, that is, by Formula (2) as follows:

τ×Zm=Xm (2).

These processes can be obtained in the following method. That is, upon using a sum Ys of the brightness Y after the level correction process, an average brightness Ym of the sum Ys, a sum Fs of the correction coefficient F, a sum Xs of the brightness X before correction, and an average Xm of the sum Xs which are obtained by the brightness sum Ys calculator 1651, the average brightness Ym calculator 1652, the coefficient sum Fs calculator 1653, the brightness sum Xs calculator 1654, the average brightness Xm calculator 1655, respectively, and using Formula (2), the reference correction degree G1 can be calculated by Formula (3) as follows:

G1=(N×Zm−Ys)/Fs=N(Xm−τ×Ym)/(τ×Fs)=−N×Δs/(τ×Fs) (3),

where N is the number of the gray scale range where the brightness Y is present and an equation of Δs=τ×Ym−Xm is satisfied.

The above calculation is performed by the correction calculator 1656. In this case, when the modulated-light ratio τ is increased indefinitely, the contrast of a high brightness area or a low brightness area may be lowered. Accordingly, by placing restrictions on the modulated-light ratio τ, it is possible to prevent the contrast thereof from being lowered. That is, when the contrast thereof is set so as not to be lowered to a value equal to or smaller than a predetermined value by performing a predetermined calculation process, a margin modulated-light ratio τ′ and a margin correction degree G1′ can be calculated by the margin correction calculator 1657. In addition, the final correction determiner 1658 determines that a final modulated-light ratio τ″ becomes a smaller one of the modulated-light ratio τ and the margin modulated-light ratio τ′ and a final correction degree G1″ becomes a smaller one of the reference correction degree G1 and the margin correction degree G1′. Then, the lightness correction executor 1659 finally performs the lightness correction process on the image data on the basis of the final modulated-light ratio τ″ and the final correction degree G1″.

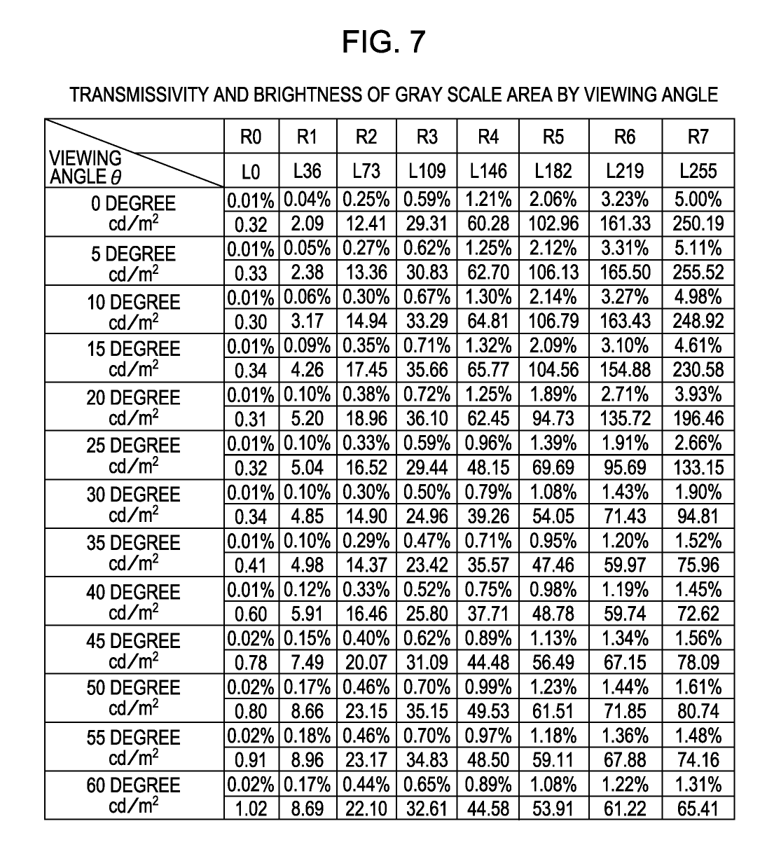

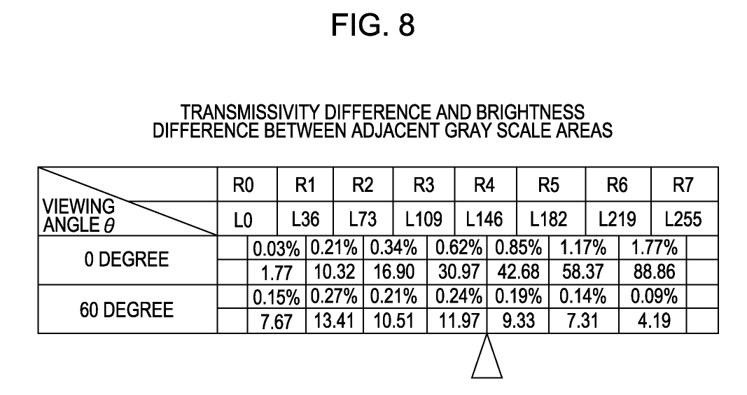

FIG. 7 shows the light outgoing ratio (the light transmissivity) of the gray scales L0 to L255 of the gray scale areas R0 to R7 in the pixels of the liquid crystal panel 110 and the image brightness when the illumination brightness of the illumination unit 140 is 5000 cd/m². FIG. 8 shows the light outgoing ratio between the adjacent gray scale areas and a difference of the image brightness at angles 0° and 60°. Such tendency is the same as that in the graph shown in FIG. 4.

In this embodiment, it is assumed that the difference of the light outgoing ratio between the adjacent gray scale areas at the high viewing angle range Hθ (particularly, a viewing angle θ=60°) is 0.2[%] and the gray scale area where the difference of the brightness between the adjacent gray scale areas is smaller and larger than 10 [cd/m²] or a predetermined gray scale value of the gray scale area is a reference gray scale domain (the reference gray scale area R4 or a reference gray scale value L146). In addition, it is assumed that the gray scale areas R5 to R7 higher than the reference gray scale area R4 is the high gray scale area and the gray scale value larger than the reference gray value L146 is a high gray scale value. In addition, it is assumed that the gray scale areas R0 to R3 lower than the reference gray scale area R4 is a low gray scale area and the gray scale value lower than the reference gray scale value L146 is a low gray scale value. In this case, it can be known that in the high viewing angle range Hθ, the difference of the light outgoing ratio between the adjacent gray scales is relatively small in the high gray scale areas or the high gray scale values (high viewing angles and high gray scale areas) (an average value of the difference of the light outgoing ratio is relatively small), and the difference of the light outgoing ratio between the adjacent gray scales is relatively large in the low gray scale areas or the low gray scale values (high viewing angles and low gray scale areas) (an average value of the difference of the light outgoing ratio is relatively large). That is, in the high viewing angle range Hθ, the difference of the light outgoing ratio between the adjacent gray scales is smaller.

On the other hand, in the low viewing angle range Lθ, the difference of the light outgoing ratio between the adjacent gray scales is relatively large in the high gray scale areas or the high gray scale values (low viewing angles and high gray scale areas), and the difference of the light outgoing ratio between the adjacent gray scales is relatively small in the low gray scale areas or the low gray scale values (low viewing angles and low gray scale areas). That is, in the low viewing angle range Lθ, the difference of the light outgoing ratio between the adjacent gray scales is larger on the contrary to the high viewing angle range Hθ.

The reference gray scale area R4 and the reference gray scale value L146 which are the reference gray scale domain are set to an area or a value in the above-mentioned relation (relation where in the high viewing angle range, the average value of the difference of the light outgoing ratio between the adjacent gray scales in the high viewing angle and high gray scale domain higher than the reference gray scale value is smaller than the average value of the difference of the light outgoing ratio between the adjacent gray scales in the high viewing angle and low gray scale domain smaller than the reference gray scale value). In this case, it is preferable that the reference gray scale area and the reference gray scale value which are the reference gray scale domain are set within the range from 45% to 65% of the total number of gray scales (that is, in 8-bit gray scale, the gray scale area R3, the reference gray scale area R4, and the gray scale area R5 or the range of the gray scale values L114 to L166). In particular, the reference gray scale area and the reference gray scale value are set within the range from 50% to 60% of the total number of gray scales (that is, in 8-bit gray scale, the reference gray scale R4 or the range of the gray scale values L127 to L154). The reason for setting the reference gray scale area and the reference gray scale value to the above range is that when the reference gray scale area and the reference gray scale value are within the range, the difference of the light outgoing ratio between the adjacent gray scales normally varies in a TN mode liquid crystal panel and the difference of the light outgoing ratio between the adjacent gray scales after and before the reference gray scale area and the reference gray scale value does not considerably vary.

In the liquid crystal panel having the above-mentioned light outgoing property, when the image data is subjected to the lightness correction process to make the image data high gray scale and the image data subjected to the lightness correction process is supplied to drive the liquid crystal panel 110, the contrast increases in the low viewing angle range Lθ but the contrast decreases in the high viewing angle range Hθ. Accordingly, when the illumination brightness of the illumination unit 140 is further decreased, a problem occurs in that the viewing angle is narrowed. On the contrary, upon making the image data low gray scale and driving the liquid crystal panel 110, the contrast decreases in the low viewing angle range Lθ but the contrast increases in the high viewing angle range Hθ. Accordingly, when the illumination brightness of the illumination unit 140 is further increased, the viewing angle is widened. In this way, upon performing the lightness correction process on the image data, the viewing angle property of an image varies in accordance with an amount of correction. Therefore, it is difficult to stably obtain a necessary viewing angle property.

In this embodiment, with reference to the reference gray scale area R4 or the reference gray scale value L146, the amount of correction in the lightness correction process is changed, or whether to perform the lightness correction process or not is determined.

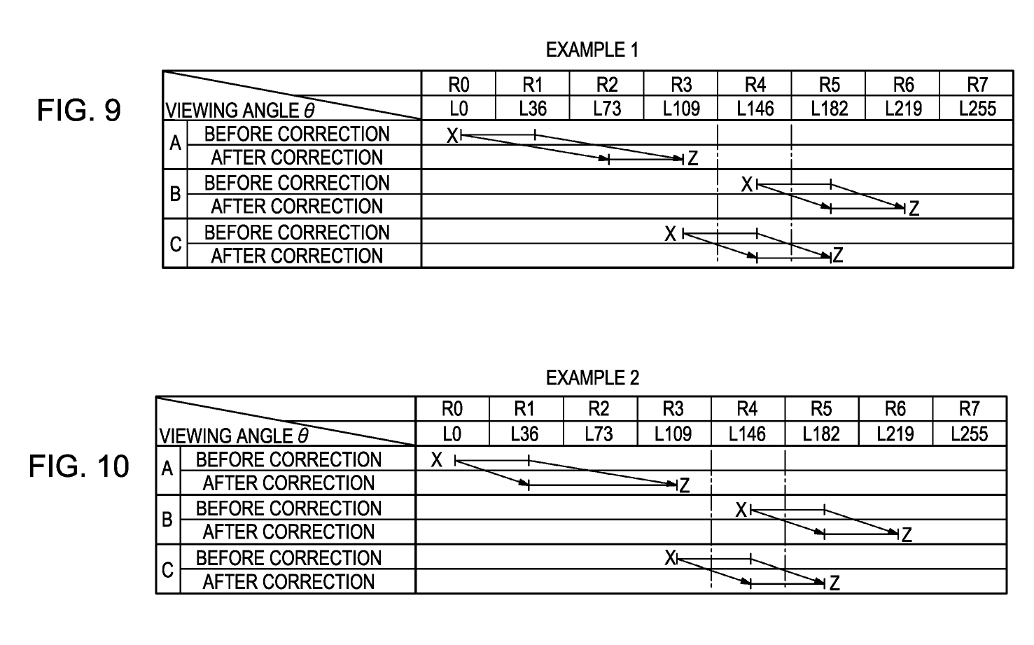

FIG. 9 is a diagram for explaining Example 1 as an example of the lightness correction process in the power saving control mode. In the power saving control mode, the gray scale of the brightness X becomes high to obtain the brightness Z, and the illumination brightness of the illumination unit 140 is decreased by setting the modulated-light ratio τ to a value less than “1”. At this time, in Example 1, on the assumption that the brightness X before correction on the image data is distributed in the range of the gray scale areas R0 and R1, the level correction process is not performed and the brightness Z after the lightness correction process so as to be distributed in the range of the reference gray scale area R4 from the gray scale areas R2 and R3. In this case, since the amount of correction in the lightness correction process from the brightness X to the brightness Z can be increased by a value corresponding to two gray scale areas while maintaining the gray scale range of the corrected brightness Z below the reference gray scale area R4 or the reference gray scale value L146, it is possible to decrease the modulated-light ratio τ in accordance with the amount of correction. At this time, the amount of correction in the lightness correction process is large to some extent, but the variation in the gray scale value does not exceed the reference gray scale area R4 or the reference gray scale value L146. Accordingly, since the variation in a brightness ratio between the low viewing angle range Lθ and the high viewing angle range Hθ is small, the variation in the viewing angle property is suppressed.

On the assumption that the brightness X before correction is distributed in the gray scale area R5 above the reference gray scale area R4 or the reference gray scale value L146 from reference gray scale area R4, the level correction process is not performed and the brightness Z after the lightness correction process to be distributed in the range of the gray scale areas R5 and R6. In this case, since the gray scale range of the corrected brightness Z is present above the reference gray scale area R4 or the reference gray scale value L146, the amount of correction is decreased from the brightness X to the brightness Z by the lightness correction process and thus the brightness is distributed in one gray scale area. Accordingly, since the reduction ratio of the modulated-light ratio τ decreases but the variation amount of brightness decreases, the variation in the brightness ratio between the low viewing angle range Lθ and the high viewing angle range Hθ is small, thereby suppressing the variation in the viewing angle property.

On the assumption that the brightness X before correction is distributed in the range of the reference gray scale area R4 from the gray scale area R3, the corrected brightness Z is corrected so as to be distributed in the range of the gray scale area R5 from the reference gray scale area R4. In this case, when the amount of correction in the lightness correction process is set to a value corresponding to two gray scale areas, the gray scale value after correction exceeds the reference gray area R4 or the reference gray scale value L146. Therefore, like the case where the brightness X before correction is distributed in the range of the gray scale area R5 from the reference gray scale area R4, the variation in the viewing angle property is suppressed by allowing the amount of correction in the lightness correction process to be small. In the illustrated example, the corrected gray scale value exceeds the reference gray scale area R4 or the reference gray scale value L146 even when the amount of correction in the lightness correction process is decreased by a value corresponding to one gray scale area.

It is possible to suppress the variation in the viewing angle property in the power saving control mode by controlling the lightness correction process in the same manner as that in Example 1. Accordingly, a stable display quality can be obtained while ensuring a power saving effect. In the above-mentioned example, the amount of correction in the lightness correction process is decreased with reference to the reference gray scale area or the reference gray value. However, the lightness correction process may not be performed on a high gray scale side, when a reference amount of correction is small in the power saving control mode, for example.

In Example 1, the case of restricting the range of the brightness before correction and after correction has been described for convenient description. However, the case where the range of the brightness is restricted like is used frequently as described above. Therefore, by using a representative gray scale range which is a predetermined frequency in histogram or a representative value (an average value or a median value) of the brightness X of the image data which is not subjected to the correction process and a preventative value (an average value of a median value) of the brightness Z of the image data subjected to the correction process instead of this range, a representative gray scale value or a representative value may be appropriately set and the lightness correction process may be changed in accordance with a relation between the representative gray scale range or the representative value and the reference gray scale area or the reference gray scale value.

Even when the distribution of the gray scales of brightness data in the input image data is scattered in the entire gray scale range, the amount of correction for the brightness data present in a specific gray scale range before the lightness correction process may be decreased or removed likewise with Example 1, when the specific gray scale range is present in a range higher than the reference gray scale area or the reference gray value. In this case, the amount of correction for the brightness data is individually changed by an original gray scale value, but the modulated-light ratio τ is set to a value corresponding to an original amount of correction in the lightness correction process. Even in this case, the amount of correction can be decreased or removed not only when the brightness X in the range of the specific gray scale before correction is set to be equal to or larger than the reference gray scale area R4 or the reference gray scale value L146, but also when the brightness X in the range of the specific gray scale before correction is smaller than the reference gray scale area or the reference gray scale value but the brightness Z after correction is larger than the reference gray scale area or the reference gray scale value.

FIG. 10 is a diagram for explaining the distribution range of the brightness X before correction and the brightness Z after correction in Example 2 as another example of the lightness correction process in the power saving control mode. In Example 2, when the distribution range of the brightness X before correction is the range of the gray scale areas R0 and R1, the distribution range of the brightness Z after correction is corrected into the gray scale areas R1 to R3. That is, the original brightness X is distributed across two gray scale areas R0 and R1, but the brightness Z after correction is distributed across three gray scale areas R1 to R3. Such expansion of the distribution range can be easily realized by the level correction process. According to the correction process, the brightness Z is widely distributed compared to the correction process. Accordingly, the brightness is just increased and the contrast can be increased on the whole.

In Example 2, the amount of correction is decreased likewise and the distribution range of brightness is not widened, when the brightness X before correction is equal to or larger than the reference gray scale area R4 or the reference gray scale value L146 or when the brightness X before correction is smaller than the reference gray scale area or the reference gray scale value but the brightness Z after correction is larger than the reference gray scale area or the reference gray scale value. Likewise with Example 1, in Example 2, it is possible to reduce power consumption and suppress the variation in the viewing angle property.

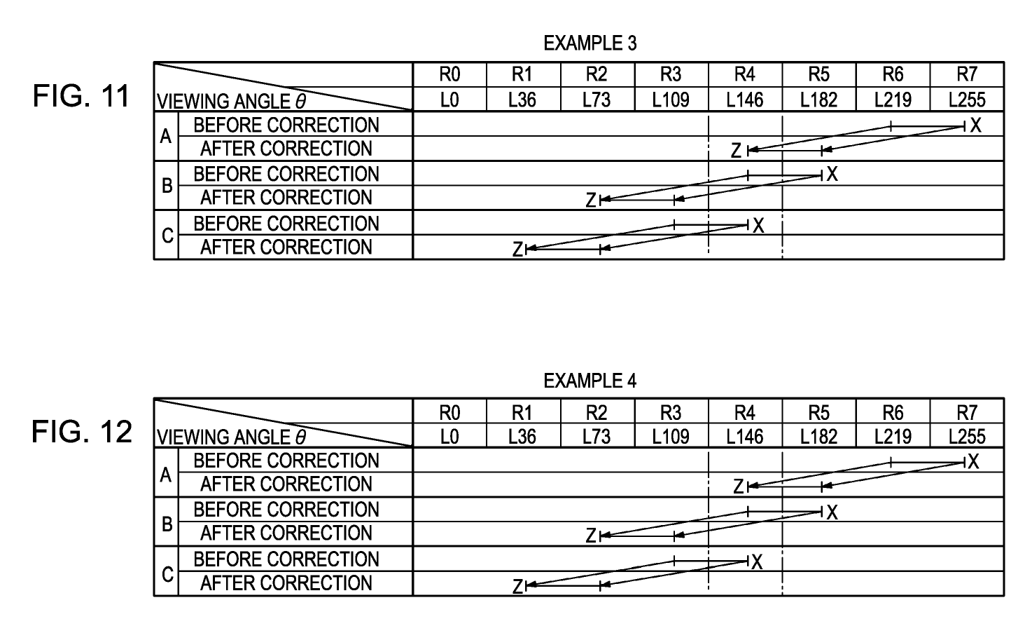

FIG. 11 is a diagram for explaining Example 3 as an example of the lightness correction process in the wide viewing angle control mode. In the wide viewing angle control mode, the image brightness itself is not decreased, but the low viewing angle range Lθ and the high viewing angle range Hθ are decreased by setting brightness to the brightness Z by the light correction process of decreasing the gray the gray scale of the brightness X and allowing the modulated-light ratio τ to be larger than “1” instead. In Example 3, by uniformly decreasing the gray scale of the brightness X before correction irrespective of the fact that the brightness X is larger than the reference gray scale area R4 or the reference gray scale value L146, it is possible to remove high gray scale values in which the difference of the light outgoing ratio between the low viewing angle range Lθ and the high viewing angle range Hθ is large. Accordingly, by mainly using the low gray scale areas in which the difference of the light outgoing ratio is small, the wide viewing angle property can be obtained.

FIG. 12 is a diagram for explaining Example 4 as still another example of the lightness correction process in the wide viewing angle control mode. Likewise with Example 3, in Example 4, the gray scale of the brightness is decreased. However, in this embodiment, the distribution range of the brightness X before correction is expanded to the gray scale areas R6 and R7, the gray scale area R5 from the reference gray scale area R4, the reference gray scale area R4 from the gray scale area R3. Accordingly, the distribution range of the brightness Z after correction is expanded in any case. In the illustrated example, an expansion ratio of the distribution range is about in the range of 1.5 times to 2.0 times. In this embodiment, since the gray scale of the brightness X is reduced to obtain the brightness Z, there is a high possibility that the contrast decreases in the light outgoing property of the liquid crystal panel when the distribution range is made equal. However, in this embodiment, by expanding the distribution range, it is possible to achieve a new wide viewing angle and particularly to maintain or improve the contrast in the low viewing angle Lθ.

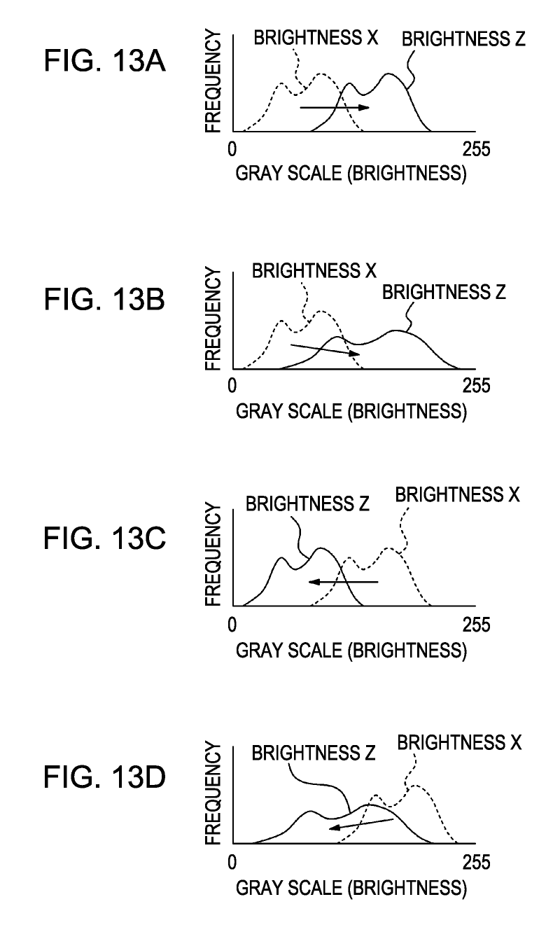

FIGS. 13A to 13D are graphs illustrating variation in the histogram before correction and after correction in the above-described examples. FIG. 13A shows that a correction process of increasing a gray scale range in distribution of the brightness X before correction in Example 1 is performed. In this case, since a distribution shape of a histogram is maintained before correction and after correction, the correction coefficient Γ(Y) is maintained as “1” and the gray scale value is shifted toward the high gray scale side by the reference correction degree G1.

FIG. 13B shows that a correction process of increasing the gray scale range of the distribution of the brightness X before correction in Example 2 on the whole and expanding the distribution range is performed. In this case, a distribution shape of a histogram is gentle and the gray scale distribution is shifted toward the high gray scale side on the whole. In this case, the level correction process of expanding the distribution range is performed in advance, the correction coefficient Γ(Y) is maintained as “1”, and the gray scale value is shifted toward the high gray scale side by the reference correction degree G1. The expansion of the distribution range results in an advantage of realizing sufficient contrast, particularly when the correction process is performed within the gray scale range below the reference gray area or the reference gray scale value.

FIG. 13C shows that a correction process of decreasing the gray scale range of the distribution of the brightness X before correction in Example 3 on the whole is performed. In this case, since a distribution shape of a histogram is maintained before correction and after correction, the correction coefficient F(Y) is maintained as “1”, and the gray scale value is shifted toward the high gray scale side by the reference correction degree G1 (negative value).

FIG. 13D shows that a correction process of decreasing the gray scale range of the distribution of the brightness X before correction in Example 4 on the whole and expanding the distribution range is performed. In this case, a distribution shape of a histogram is gentle and the gray scale distribution is shifted toward the low gray scale side on the whole. In this case, the level correction process of expanding the distribution range is performed in advance, the correction coefficient Γ(Y) is maintained as “1”, and the gray scale value is shifted toward the high gray scale side by the reference correction degree G1 (negative value). The expansion of the distribution range results in an advantage of realizing sufficient contrast, even when the correction process of decreasing the gray scale range below the range of the reference gray area or the reference gray scale value is performed.

As an applied example of the control method described above, it is possible to intend narrowing the viewing angle of display of the liquid crystal display device. That is, image data in the reference gray scale range or a range lower than the reference gray scale range is subjected to a correction process, so that the image data subjected to the correction process is shifted toward the high gray scale side more than the reference gray scale value. In addition, image data in a range higher than the reference gray scale range is also subjected to a correction process of lightening a display. By controlling such a manner, a bright image having a large dependency on the viewing angle of the display image can be obtained. In particular, upon performing such control in the power saving control mode for decreasing the brightness of the illumination unit, an image having an excellent contrast property can be obtained without deteriorating the bright image only when the image is viewed from a front side.

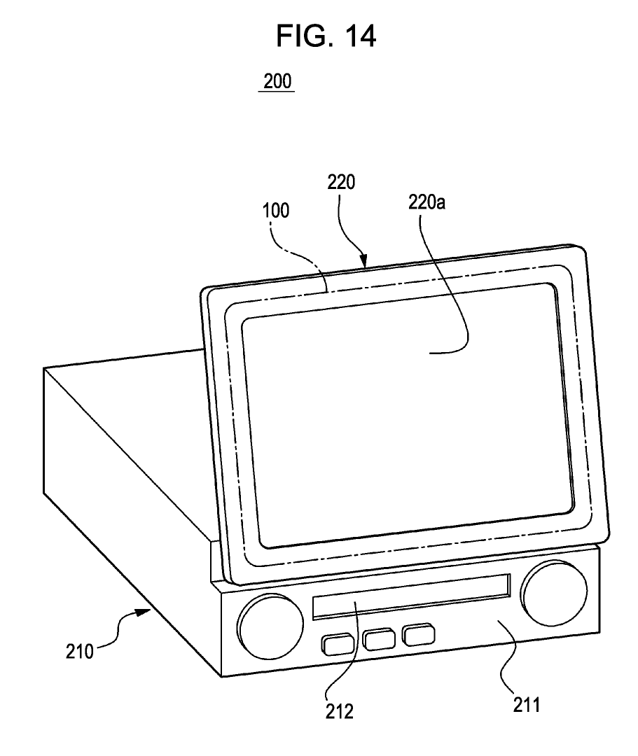

FIG. 14 is a schematic perspective view illustrating an example of an electronic apparatus mounted with the display apparatus 10 according to this embodiment. As illustrated, an electronic apparatus 200 is a car navigation system for a vehicle which includes a body unit 210 and a display unit 220 connected to the body unit 210. The body unit 210 is provided with a manipulation surface 211 mounted with manipulation buttons and the like and a feeding port 212 for feeding a recording medium such as a DVD. The liquid crystal display device 100 is received inside the display unit 220. A display screen of the display area of the liquid crystal display device 100, that is, a display screen 220a of the display unit 220 is provided so that a display of a navigation image is viewed.

In the electronic apparatus 200 including a vehicle monitor, the display unit 220 needs to be viewed in a range of a relatively wide viewing angle. Therefore, variation in the viewing angle has a great effect on a display quality and a viewing angle wider than a typical angle is necessary. In this case, by using the display apparatus 10 described above, it is possible to realize an electronic apparatus having a stable display quality.

The entire disclosure of Japanese Patent Application No. 2008-22426 filed Feb. 1, 2008, and 2008-197470 filed Jul. 31, 2008 are expressly incorporated by reference herein.

What is claimed is:

1. A method of controlling a liquid crystal display device which includes a liquid crystal panel with pixels displaying an image in accordance with a gray scale value, the method comprising:
setting a first gray scale area containing a plurality of gray scale values and a second gray scale area containing a plurality of gray scale values larger than the gray scale values contained in the first gray scale area;
performing a first lightness correction process of increasing lightness of the image on image data when the gray scale values which are based on the image data belong to the first gray scale area; and
performing no lightness correction process on image data or a second lightness correction process to correct the image data by a correction amount smaller than a correction amount of the first lightness correction when the gray scale values which are based on the image data belong to the second gray scale area.

2. The method according to claim 1,
wherein the liquid crystal panel includes the plurality of pixels,
the method further comprising:
determining one of the gray scale values as a representative value on the basis of a plurality of the image data input to the plurality of pixels;
performing the first lightness correction process on the plurality of image data input to the plurality of pixels when the one gray scale value belongs to the first gray scale area; and
performing no lightness correction process on the plurality of image data input to the plurality of pixels or the second lightness correction process to correct the plurality of image data by the correction amount smaller than the correction amount of the first lightness correction when the one gray scale value belongs to the second gray scale area.

3. The method according to claim 1,
wherein the liquid crystal display device further includes an illumination unit illuminating the liquid crystal panel, and
wherein the illumination unit selects a first state of emitting first brightness light and a second state of emitting second brightness light lower than the first brightness light in brightness,
the method further comprising performing the first or second lightness correction process in the second state.

4. The method according to claim 3, further comprising performing a third lightness correction process of decreasing lightness of the image on the image data in the first state.

5. A method of controlling a liquid crystal display device which includes a liquid crystal panel with pixels displaying an image in accordance with a gray scale value and an illumination unit illuminating the liquid crystal panel,
wherein the illumination unit selects a first state of emitting first brightness light and a second state of emitting second brightness light lower than the first brightness light in brightness,
the method comprising performing a third lightness correction process of decreasing lightness of the image on image data in the first state.

6. A liquid crystal display device in which a first gray scale area containing a plurality of gray scale values and a second gray scale area containing a plurality of gray scale values larger than the gray scale values contained in the first gray scale area are set, the liquid crystal display device comprising:
an image correction unit which performs a first lightness correction process on image data when the gray scale values which are based on the image data belong to the first gray scale area and performs no lightness correction process on image data or a second lightness correction process to correct the image data by a correction amount smaller than a correction amount of the first lightness correction process when the gray scale values which are based on the input image data belong to the second gray scale area; and
an image display unit which displays an image on the basis of a value output by the image correction unit.

7. The liquid crystal display device according to claim 6, further comprising a representative gray scale value determination unit which determines one of the gray scale values as a representative value on the basis of a plurality of image data,
wherein the image correction unit performs the first lightness correction process on the plurality of image data input to the plurality of pixels when the one gray scale value belongs to the first gray scale area, and
wherein the image correction unit performs no lightness correction process on the plurality of image data input to the plurality of pixels or the second lightness correction process to correct the plurality of image data by the correction amount smaller than the correction amount of the first lightness correction when the one gray scale value belongs to the second gray scale area.

8. The liquid crystal display device according to claim 6, further comprising:
an illumination unit which illuminates the liquid crystal panel; and
an illumination brightness adjustment unit which selects a first state where the illumination unit emits first brightness light and a second state where the illumination unit emits second brightness light lower than the first brightness light in brightness,
wherein the image correction unit performs the first or the second lightness correction process when the illumination unit is in the second state.

9. A liquid crystal display device which includes a liquid crystal panel with pixels displaying an image in accordance with a gray scale value and an illumination unit illuminating the liquid crystal panel, the liquid crystal display device comprising:
an illumination brightness adjustment unit which selects a first state where the illumination unit emits first brightness light and a second state where the illumination unit emits second brightness light lower than the first brightness light in brightness; and
an image correction unit performs a correction process of decreasing lightness of the image on image data when the illumination unit is in the first state.

10. An electronic apparatus comprising the liquid crystal display device according to claim 6.
